(19) United States
(12) Patent Application Publication
(10) Pub. No.: US 2023/0114094 A1
(43) Pub. Date: Apr. 13, 2023

(54) INTEGRATED CENTER AND PROCESS FOR RECYCLING BOTH POLYOLEFIN AND POLYESTER

(71) Applicant: REPUBLIC SERVICES, INC., PHOENIX, AZ (US)

(72) Inventors: John Joseph Riconosciuto, West Chicago, IL (US); Peter J. Keller, Phoenix, AZ (US); Prabhu Soundarrajan, Phoenix, AZ (US)

(21) Appl. No.: 17/964,103

(22) Filed: Oct. 12, 2022

Related U.S. Application Data
(60) Provisional application No. 63/254,709, filed on Oct. 12, 2021.

(51) Int. Cl. C08J 11/08; B09B 3/35

(52) U.S. Cl. CPC C08J 11/08; B09B 3/35; C08J 2367/00

(57) ABSTRACT

An integrated, automated process for separating and recycling a broad mix of plastic waste material including, without limitation, polyester and polyolefin streams. The process begins by collecting the material. The material is then pre-processed to remove contamination. Next, the material is coarsely shredded, resulting in ground material. The ground material is friction washed to remove further contaminants from the ground material and form cleaned ground material. The cleaned ground material is sink floated to further wash the clean ground material and separate it into polyolefin flakes and polyester remainder. The polyester remainder is dried, yielding polyester flakes. Finally, the polyester flakes are collected. The process eliminates the tradeoffs between recovery and purity that perplex recycling facilities and permits simultaneous handling of polyesters and polyolefins. Also provided are a related center (and an infrastructure including the center) and at least one computer-readable non-transitory storage medium embodying software for performing the process.

### RELATED APPLICATION

This application claims the benefit of priority to U.S. Provisional Patent Application Ser. No. 63/254,709, filed on Oct. 12, 2021, the contents of which are incorporated in this application by reference.

### TECHNICAL FIELD

The present disclosure relates generally to the problem of recycling plastic waste material and, more particularly, to separating and recycling an aggregated mix of plastic waste material.

### BACKGROUND OF THE INVENTION

Plastics are inexpensive, lightweight, and durable materials, which can readily be molded into a variety of products that find use in a wide range of applications. As a consequence, the production of plastics has increased markedly over the last 60 years. Unfortunately, current levels of plastics usage and disposal generate several environmental problems. About 4% of world oil and gas production, a non-renewable resource, is used as feedstock for plastics and a further 3-4% is expended to provide energy for their manufacture. A major portion of plastics produced each year is used to make disposable items of packaging or other short-lived products that are discarded within a year of manufacture. These two observations alone indicate that our current use of plastics is not sustainable. In addition, substantial quantities of discarded end-of-life plastics are accumulating as debris in landfills and in natural habitats worldwide because of the durability of the polymers involved.

Recycling is one of the most important actions currently available to reduce these impacts and represents one of the most dynamic areas in the plastics industry today. Recycling provides opportunities to reduce oil usage, carbon dioxide emissions, and the quantities of waste requiring disposal. Although plastics have been recycled since the 1970s, the quantities that are recycled vary geographically, according to plastic type and application. Recycling of packaging materials has seen rapid expansion over the last decades in a number of countries. Advances in technologies and systems for collecting, sorting, and reprocessing recyclable plastics are needed to create new opportunities for recycling, and with the combined actions of the public, industry, and governments it may be possible to divert the majority of plastic waste from landfills to recycling over the next decades.

Recycling is the process of turning used materials and waste into new products. There are many reasons to recycle. Among those reasons are a reduction in the air, water, and land pollution that is caused by discarded or burnt waste, meaning that the air we breathe, the water we drink, and the land on which we live are safer and healthier. The recycling process is one of the most effective ways that we can help preserve our planet and make sure that it is a healthy place to live. Recycling further reduces the amount of waste sent to landfills and incinerators. Recycling still further reduces our reliance on increasingly scarce natural resources and raw materials such as timber, water, and minerals when manufacturing new products. It takes less energy to recycle used materials than it does to produce items with raw materials, and saving energy is good both for the environment and for consumers because recycling reduces the prices of products. Recycling also creates jobs for people, as recycling companies employ many thousands of workers all over the world. Therefore, as the reasons outlined above show, the recycling process helps more than just the environment.

We should all recycle everything that is capable of going through the recycling process. Much of our household and commercial (e.g., industrial) waste can be broken down and reprocessed to make new products. Among the common materials that can and should be recycled include plastic such as bottles, carrier bags, tubs, food containers, and wrappers.

Recycling includes the following three steps, which create a continuous loop, represented by the familiar recycling symbol comprising three arrows that form a circle. The first step is the collection and processing of recyclables. There are several methods for collecting recyclables, including curbside collection, drop-off centers, and deposit or refund programs. After collection, recyclables are sent to a materials recovery facility (“MRF”) also known, more generally, as a recycling center to be sorted, cleaned, and processed into materials that can be used in manufacturing. Recyclables are bought and sold just like raw materials would be, and prices go up and down depending on supply and demand in the United States and the world. This disclosure focuses on the step of collecting and processing recyclable plastics.

In the second step of the recycling process, products are manufactured with recycled materials either collected from a recycling program or from waste recovered during the normal manufacturing process. More and more products are being manufactured with recycled content and product labels will sometimes include how much of the content was from recycled materials. Finally, in the third step of the recycling process, consumers close the recycling loop by buying new products made from recycled materials. Consumers should look both for products that contain recycled content and for products that can be easily recycled.

The first step of the recycling process, collecting and processing recyclables, has historically been accomplished manually. This labor-intensive process created a need to automate the steps of collecting and processing recyclables to increase productivity. More recently, recyclables are sorted at the MRF into different material streams by machines which reduce but do not eliminate the need for manual recovery and quality control.

A need remains, however, to better ensure that the highest quality and cleanest recyclable materials are extracted during the sorting process at the MRF. High standards of quality ensure that materials collected for recycling can be most efficiently turned into high-grade feedstock that fetches the best prices in the marketplace for recyclable material. Thus, the work that recycling sorters do is essential to the overall functioning of the process. Yet that work can be time consuming. Needs exist to eliminate the tradeoffs between recovery and purity that perplex recycling facilities and to permit simultaneous handling of polyesters and polyolefins.

To overcome the shortcomings of the known technology, a new automated process (or method) for plastics separating and recycling is provided by the present disclosure. An object of the present disclosure is to meet the need for producing high-quality, market-ready, post-consumer plastics across multiple types of plastic under one roof. A related object is to provide an integrated process to separate different plastic feedstock by aggregating and processing the different plastics (e.g., polyolefin and polyester) in the same facility via a hub and spoke infrastructure. Another object is to achieve a high quality of recyclable material regardless of the source. A need remains in the recycling market for a process that can aggregate mixed plastic waste materials and separate them into pure streams of clean recycled plastic materials suitable for manufacturing new products.

It is still another object of the present disclosure to improve the processing of plastic waste materials containing a mix of various types of plastics for recycling the contents of the mixed waste materials. Another object is to recover the maximum amount of high quality recyclable materials from the various categories and types of mixed plastic waste materials with a minimum degradation or damage to the recovered materials. Still another object is to provide a vertically integrated process of recycling different polymer feedstock, including polyolefin and polyester, in the same facility or center via a hub and spoke infrastructure.

A further object of the present disclosure is to leverage economies of scale and aggregate mixed plastics from several recycling facilities and sort them into purified recycled streams for end-customers. A still further object is to reduce capital expenditure and operating expenditure at recycling facilities. Yet another object is to homogenize curbside programs across feeder markets regardless of local recycling processing capabilities through centralizing complexity at the recycling facility location.

MRFs currently face tradeoffs between recovery and purity. The more material that is recovered, the greater the need for quality management. Conversely, if higher-quality products need to be shipped, more desirable material will be missed and find its way to the residue. There remains a need to eliminate the tradeoff by introducing a process of integrated secondary processing of contaminated material without sacrificing recovery and purity at MRFs.

### SUMMARY OF THE DISCLOSURE

To achieve these and other objects and to meet these and other needs, and in view of its purposes, the present disclosure provides an automated process for separating and recycling a broad mix of plastic waste material including, but not limited to, polyolefin and polyester streams. The process begins by collecting the broad mix of plastic waste material. The broad mix of plastic waste material is then pre-processed to remove contamination from the broad mix of waste material. Next, the broad mix of plastic waste material is coarsely shredded or ground, resulting in ground material. The ground material is friction washed to remove dirt, sand, grease, and other contaminants from the ground material. The ground material is sink floated to further wash and separate the ground material into polyolefin flakes and polyester remainder. The polyester remainder is dried, resulting in polyester flakes. Finally, the polyester flakes are collected. The polyolefin flakes and the polyester flakes can then be used to manufacture a variety of new products. Also provided are a related system (and an infrastructure including the system) and at least one computer-readable non-transitory storage medium embodying software for performing the process.

The related system for separating and recycling a broad mix of plastic waste material including, but not limited to, polyolefin and polyester streams, has the following components. A mechanism collects the broad mix of plastic waste material. A series of optical sorters pre-process the broad mix of plastic waste material to remove contamination from the broad mix of plastic waste material. A shredder coarsely shreds or grinds the broad mix of plastic waste material, resulting in ground material. A friction washing machine removes dirt, sand, grease, and other contaminants from the ground material. A sink float separation tank further washes and separates the ground material, resulting in polyolefin flakes and polyester remainder. A dryer unit dries the polyester remainder, resulting in polyester flakes. Again, the polyolefin flakes and the polyester flakes can be used to manufacture a variety of new products.

A hub and spoke infrastructure incorporates multiple of the systems for separating and recycling a broad mix of plastic waste material including, but not limited to, polyolefin and polyester streams. The infrastructure includes three, main components: (1) a plurality of materials recovery facilities that collect a first portion of the broad mix of plastic waste material; (2) a number of recycling facility/transfer stations that both collect a second portion of the broad mix of plastic waste material and receive from at least one materials recovery facility the mixed plastic waste material collected by the at least one materials recovery facility; and (3) multiple of the integrated plastic recycling centers, each center collecting the broad mix of plastic waste material from one or more of the plurality of materials recovery facilities, from one or more of the recycling facility/transfer stations, or from both one or more of the plurality of materials recovery facilities and one or more of the recycling facility/transfer stations. Each of the multiple centers is located geographically in relative proximity to the one or more materials recovery facilities, the one or more recycling facility/transfer stations, or to both the one or more materials recovery facilities and the one or more recycling facility/transfer stations from which the center collects the broad mix of plastic waste material.

The at least one computer-readable non-transitory storage medium embodies software that is operable when executed to: (a) collect a broad mix of plastic waste material including, but not limited to, polyolefin and polyester streams; (b) pre-process the broad mix of plastic waste material to remove contamination from the broad mix of plastic waste material; (c) coarsely shred or grind the broad mix of plastic waste material, resulting in ground material; (d) friction wash the ground material to remove dirt, sand, grease, and other contaminants from the ground material; (e) sink float the ground material to further wash and separate the ground material, resulting in polyolefin flakes and polyester remainder; (f) dry the polyester remainder, resulting in polyester flakes; and (g) collect the polyester flakes. Once again, the polyolefin flakes and the polyester flakes can be used to manufacture a variety of new products.

The present disclosure also provides an integrated process that constitutes recycling facilities (including both residential and industrial) and secondary processing centers with enhanced sorting, separating, and processing capabilities. The process includes delivering a stream or streams of recyclable waste material (e.g., a residential single stream (RSS)) to recycling facilities wherein large volume materials including cardboard, glass, aluminum, and steel are sorted, baled, and sold to converters; sending remaining material to secondary processing centers for further refinement, wherein the recycling facility enables market area collection and the secondary processing center is a larger regional hub; aggregating material on a regional basis; and sending a concentrated stream of difficult-to-process material through a purpose-built separation process step which would not be practical or economical on a de-centralized basis. The integrated process further includes separating the difficult-to-process material that includes rigid plastics into bales of primarily polyester in a first line and primarily polyolefin in a second line.

The present disclosure teaches a function of automation with a defined process which presents considerable advantages over known technology. Among the advantages are scalability; higher plastic mix recyclable recovery; and greater circularity, safety, and efficiency. The present disclosure further teaches a process for capturing the most possible plastic with the highest possible quality in MRFs while using existing infrastructure and adding an integrated secondary processing infrastructure (e.g., regional hub and spoke model). The present disclosure still further teaches a process, a business model, and infrastructure characterized by deliberately simplifying the primary processing at the recycling facility and enabling lower operating expenses for processing at MRFs that assure efficiency, high recovery, and high purity through integration.

The present disclosure also teaches a process that intentionally captures polyester for food-grade applications and olefins (e.g., caps and rings) through a float-sink step while also producing high-quality olefin bales (not including caps and rings) within the same center as part of the integrated process. Conventional processes are either focused on polyesters or polyolefins, with each process viewing the other family of resins as byproduct which distracts from the primary activity, and do not present the advantages of integrated processing as disclosed.

To clarify, conventional polyester recycling goes through a sink/float process; the sinking material is recovered as a primary product, while the floating olefinic fraction is typically captured and sold at a deep discount to be downcycled. Additional olefins are removed through the optical sorting process, which are either discarded or downcycled. Conventional olefin recycling also goes through a sink/float process, in which the floating material is further refined and the sinking fraction is typically sent to landfill.

Because the disclosed process runs both types of resin under one roof, the “byproducts” from processing each resin are typically able to be treated as primary products in the other system. This reduces overall waste to landfill, and it also prevents the downcycling that happens with conventional recycling processes.

It is to be understood that both the foregoing general description and the following detailed description are exemplary, but are not restrictive, of the disclosure.

### BRIEF DESCRIPTION OF THE DRAWING

The disclosure is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 shows an overview of an operating model including an integrated plastic recycling center according to the present disclosure;

FIG. 2 depicts an example mix of recyclable plastic waste material that might be provided to the integrated plastic recycling center in a process according to the present disclosure;

FIG. 3 shows an overview or flow chart illustrating an automated process for separating and recycling a broad mix of plastic waste material in the integrated plastic recycling center according to the present disclosure;

FIG. 4 depicts the products that result from the various steps in the process illustrated in FIG. 3;

FIG. 5 illustrates an example computer system that can be used in the process according to the present disclosure;

FIG. 6 illustrates an ecosystem for the circular plastic bottle economy, focusing on recycling beverage bottles made of polyethylene terephthalate;

FIG. 7 illustrates the flow of material and credits in a Verra Plastic Standard project example in which plastic waste is collected from the environment; and

FIG. 8 illustrates an example embodiment of a nationwide hub and spoke infrastructure for recycling a broad mix of plastic waste material made possible by the integrated plastic recycling center according to the present disclosure.

### DETAILED DESCRIPTION OF THE DISCLOSURE

In this specification and in the claims that follow, reference will be made to a number of terms which shall be defined to have the following meanings ascribed to them.

The term “about” means those amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is described to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point. Whether or not a numerical value or end-point of a range in the specification recites “about,” the numerical value or end-point of a range is intended to include two embodiments: one modified by “about” and one not modified by “about.” It will be further understood that the end-points of each of the ranges are significant both in relation to the other end-point and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for components and steps, and ranges thereof, are for illustration only; they do not exclude other defined values or other values within defined ranges. The components and process steps of the disclosure include those having any value or any combination of the values, specific values, more specific values, and preferred values described.

The indefinite article “a” or “an” and its corresponding definite article “the” as used in this disclosure means at least one, or one or more, unless specified otherwise. “Include,” “includes,” “including,” “have,” “has,” “having,” comprise,” “comprises,” “comprising,” or like terms mean encompassing but not limited to, that is, inclusive and not exclusive.

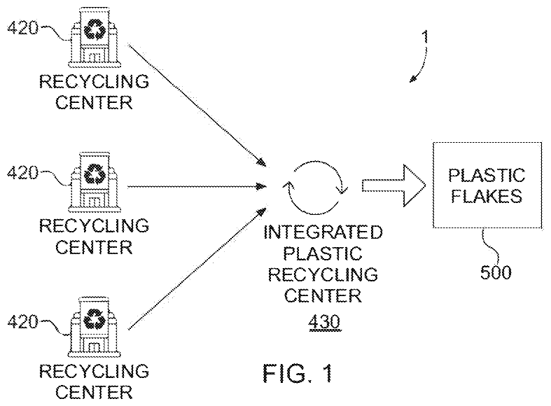

Referring now to the drawing, in which like reference numbers refer to like elements throughout the various figures that comprise the drawing, FIG. 1 shows an overview of an operating model 1 including an integrated plastic recycling center 430 for recycling plastics such as polyolefin and polyester according to the present disclosure. The operating model 1 begins by collecting mixed plastic waste material 10 from a large variety of sources at a plurality of recycling facilities or materials recovery facilities (“MRFs”) 420. Although three MRFs 420 are shown in FIG. 1, any number of MRFs 420 can be included in the operating model 1.

As shown in FIG. 1, the integrated plastic recycling center 430 receives the mixed plastic waste material 10 from the MRFs 420. At the integrated plastic recycling center 430, a process 100 is applied according to the present disclosure which is discussed in detail below. The process 100 sorts, cleans, and processes the mixed plastic waste material 10 into intermediate products 500 that can be used in manufacturing. One example of an intermediate product 500 is plastic flakes.

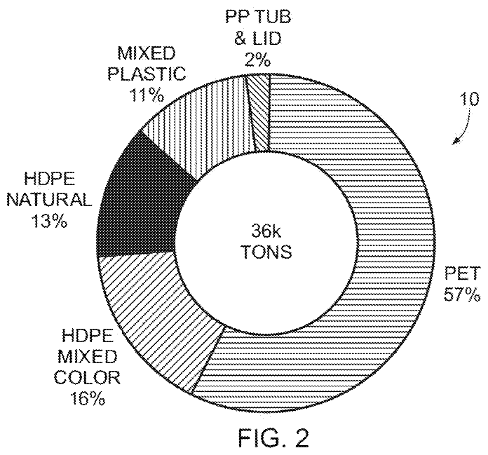

FIG. 2 depicts an example mix of recyclable plastic waste material 10 that might be collected at the MRFs 420 and provided to the integrated plastic recycling center 430. The mixed plastic waste material 10 that is collected at the MRFs 420 includes any and all types of recyclable plastics, such as polyethylene terephthalate (PET) bottles, linear low density polyethylene (LLDPE) and low density polyethylene (LDPE) films, polypropylene (PP) strapping, high density polyethylene (HDPE) crates, polystyrene (PS) foam, and the like. In the one example depicted in FIG. 2, the mixed plastic waste material 10 amounts to 36,000 tons including 57% PET, 16% mixed color HDPE, 13% natural HDPE, 11% mixed plastic, and 2% PP tubs and lids. The amounts and contents of the mixed plastic waste material 10 provided to the integrated plastic recycling center 430 can vary, of course, by such factors as program design, consumptive behavior, and facility capabilities.

PET is the most commonly used thermoplastic polymer resin in the world. A member of the polyester family, PET is used in fibers for clothing, containers for liquids and foods, thermoforming for manufacturing, and in combination with glass fiber for engineering resins. PET is a semi-aromatic polymer synthesized from ethylene glycol and terephthalic acid. PET has a glass transition temperature of 67-81° C. and a melting point of 260° C. PET bottles can be recycled by chemically depolymerizing the PET chain into its monomers or various valuable chemicals.

A polyolefin is a type of polymer with the general formula (CH₂CHR)ₙ. Polyolefins are derived from a handful of simple olefins (alkenes). Dominant in a commercial sense are polyethylene (PE) and PP. More specialized polyolefins include polybutene, polyisobutylene, and polymethylpentene. Myriad copolymers are known. They are all colorless or white oils or solids. The name polyolefin indicates the dominant olefin from which they are prepared, i.e., ethylene, propylene, butene, isobutene, and 4-methyl-1-pentene. Distinguish polyolefins, however, from olefins. Polyolefins are the foundations of many chemical industries.

Polyester and polyolefin are two categories of plastics. The difference between polyolefin (e.g., PE and PP) and polyester (e.g., PET) is that polyolefin is a polymer made by the polymerization of an olefin and polyester is any polymer whose monomers are linked together by ester bonds. The process 100 disclosed in this document offers one of the needed advances in technologies and systems for recycling plastics. Recyclers rarely, if ever, handle both types of plastics. The process 100 enables recyclers to handle both.

The process 100 also enables conversion of film plastics that have been challenging to recycle due to manual separation (as done in conventional recycling). Current single-stream recycling facilities generate 3-4 broad streams of plastics, with comparatively high levels of plastics cross-contamination. Plastics manufacturers are narrowly focused on specific types of plastics based on their respective targeted products (e.g., PET bottlers view HDPE as a waste “residue” in the stream). Plastics manufacturers currently sort these broader streams of plastics for desired plastic content but throw away other forms of valuable plastic. The market is missing a player who can aggregate mixed plastics and separate the aggregate into pure plastic streams to supply plastics manufacturers—unlocking value for currently discarded plastics.

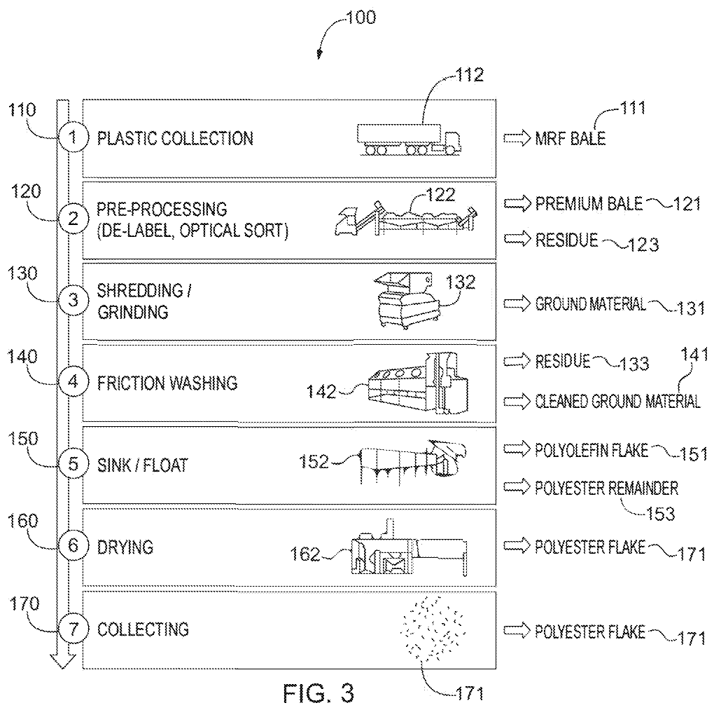

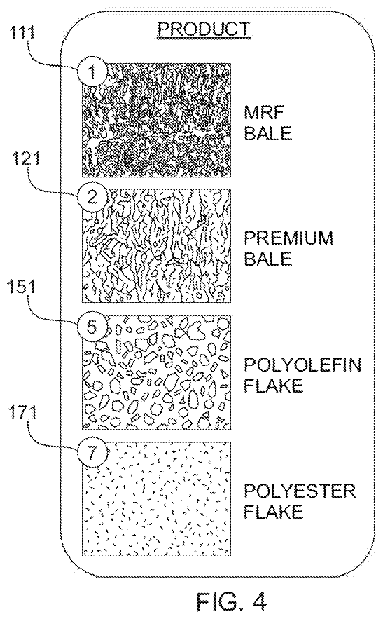

FIG. 3 is flow chart that summarizes the steps of the example automated process 100. FIG. 4 illustrates the products that result from each of the steps of the example automated process 100. Those steps include the following:

Step 110: Collect a broad mix of plastic waste material 10, often resulting in an MRF bale 111;

Step 120: Pre-process (de-label, optical sort) the broad mix of plastic waste material 10 to remove contamination, resulting in a premium bale 121;

Step 130: Coarsely shred or grind the decontaminated (sorted) premium plastic waste material, resulting in ground material 131;

Step 140: Friction wash the ground material 131 to remove dirt, sand, grease, and other contaminants from the ground material 131 to form a residue 133 and cleaned ground material 141;

Step 150: Sink float the cleaned ground material 141 to further wash and separate the plastic flakes, resulting in polyolefin flake 151 and a polyester remainder 153;

Step 160: Dry the polyester remainder 153 to create polyester flake 171; and

Step 170: Collect the polyester flake 171.

Details about each of the steps are provided below.

During the first step 110 of the process 100, the broad mix of plastic waste material 10 is collected at the MRFs 420 where it is often (although not necessarily) packaged as tightly compacted MRF bales 111 of considerable size and weight. The main advantages of baling the broad mix of plastic waste material 10 are: (1) ease of handling, transport, and storage; (2) bales are compatible with the recycling machines to recycle any plastic waste which can be reused; and (3) the storage of baled waste is more compact by which optimal usage of the storage space can be done for stocking the plastic waste material 10. Whether baled or not, the collected broad mix of plastic waste material 10 is transported (e.g., using a vehicle such as a truck 112, train, plane, and the like) to the integrated plastic recycling center 430.

As illustrated in FIG. 3, the second step 120 of the process 100 involves pre-processing (de-label, optical sort) the broad mix of plastic waste material 10 to remove contamination. Although pre-processing could be done manually, an automated pre-processing step is preferred. Example contaminants include labels, liquids, and food waste. Certain non-recyclable plastics may constitute contaminants because stable, profitable markets do not currently exist for such plastics.

An optical sorter 122 preferably helps to automate the second step 120. Optical sorting (sometimes called digital sorting) is the automated process of sorting solid products using cameras, lasers, or both cameras and lasers. Depending on the types of sensors used and the software-driven intelligence of the image processing system, optical sorters can recognize the color, size, shape, structural properties, and chemical composition of an object. An optical sorter compares objects to user-defined accept/reject criteria to identify and separate products of different types of materials. Optical sorting achieves non-destructive, almost 100% inspection and sorting at full production volumes. Compared to manual sorting, which is subjective and inconsistent, optical sorting helps improve product quality, maximize throughput, and increase yields while reducing labor costs.

The optical sorter 122 accepts the broad mix of plastic waste material 10, separates it into two or more streams, and re-directs those streams to their respective processing lines for further processing in parallel. The broad mix of plastic waste material 10 might include, for example, polyolefins, polyesters, and residue (unwanted materials such as contaminants). In that case, the optical sorter 122 separates the broad mix of plastic waste material 10 into a first premium bale 121 of polyolefins, a second premium bale 121 of polyesters, and a stream of residue 123. Thus, the integrated plastic recycling center 430 can operate multiple lines specific to polymer resin types to produce premium products. The optical sorter 122 may include, but is not limited to, near infra-red (NIR) reflection technology to separate by one or more of resin type, molecular composition, and color using automated visual recognition (e.g., a digital camera).

The third step 130 of the process 100 involves coarsely shredding or grinding the decontaminated (sorted) premium plastic waste material. The third step 130 can be accomplished using a shredder 132. The shredder 132 is a heavy-duty tool that can shred the components that comprise the premium plastic waste material. The shredder 132 may be floor-standing or attach to a wall. The shredder 132 includes metal blades that cut through the premium plastic waste material. This occurs as the premium plastic waste material enters the shredder 132 from underneath. The premium plastic waste material then is turned into small pieces by powerful rotating drums on either side of the blade assembly. After processing, the broken chunks of premium plastic waste material are sent out of the shredder 132 via an exhaust chute as ground material 131. In some applications, a dust collector is provided on the shredder 132.

In the fourth step 140 of the process 100, an industrial friction washing machine 142 is used to wash the ground material 131. The fourth step 140 removes dirt, sand, grease, and other contaminants from the ground material 131 to form a further residue 133 and a cleaned ground material 141. The main components of the friction washing machine 142 are a large rotor with several arrays of paddles, detachable dewatering screens that enclose the rotor, and a cleaning manifold for water injection. The friction washing machine 142 is configured on an inclined frame, preferably slanted at 45 degrees to maximize friction. The fast-rotating shaft and paddles transport the ground material 131 up the incline and hit the materials against the screen, similar to how a laundry machine works. (The working principle is based on mechanical friction and centrifugal force, just like a laundry machine.) Dirt, sand, grease, and other contaminants are then driven out of the ground material 131, and sprayed away by water nozzles. The dirty water and contaminants then discharge at the bottom of the friction washing machine 142 as the further residue 133. The cleaned materials leave at the top of the friction washing machine 142 as the cleaned ground material 141. The result of the process 100 after completing the fourth step 140 is that the ground material 131 has been washed clean of dirt, sand, grease, and other contaminants. Washing is an important step to increase the value of the desired end products.

The fifth step 150 of the process 100 involves further washing and separating the cleaned ground material 141. In one embodiment, as illustrated in FIG. 3, a sink float separation tank 152 is used to complete the fifth step 150. The sink float separation tank 152 can efficiently and effectively separate PET plastic, the plastic that makes up many bottles, from PP and PE plastic, the plastic that makes up many bottle caps and labels. A suitable sink float separation tank 152 is between 4-6 meters long and includes specially designed rotating drums to move the plastic pieces forward and into water. The process allows the materials to separate properly and soak for long periods of time, resulting in a cleaner material stream of polyolefin flake 151 (the float portion) and a polyester remainder 153 (the sink portion). To ensure durability, the interior walls and rotating drums of the sink float separation tank 152 are made of high-quality, 304-type stainless steel that is strongly resistant to both corrosion and oxidation (rust).

The sink float separation tank 152 uses water as the medium to separate co-mingled plastics based on densities. Water has a density of 1 g/cm³. As the cleaned ground material 141 enters the sink float separation tank 152, any plastic with a density greater than water will sink (PET has a density of 1.38 g/cm³). This heavy plastic stream collects at the bottom of the tank and exits the sink float separation tank 152 using a screw conveyor. Likewise, any plastic with a density less than water (such as PP and PE) will float and exits the sink float separation tank 152 at the top. Additives can also be added to improve the separation process.

The sixth step 160 of the process 100 involves drying the polyester remainder 153. PET is an effective desiccant. The amount of water absorbed by PET depends on relative humidity, residence time, temperature, and dimensions of the flakes. When PET flakes containing moisture are heated to the melting temperature, hydrolytic degradation occurs lowering a viscosity of the melt that results in enhanced ability of preforms/bottles to crystallize (milky appearance). Therefore, drying of PET flakes at temperature levels of about 160-180° C. to a moisture content below about 0.005% is helpful to produce the most valuable recycled materials.

In one embodiment, as illustrated in FIG. 3, a drying unit 162 is used to complete the sixth step 160. The dryer and the hopper of the drying unit 162 are of standard design. An internal agitator (propeller) keeps the amorphous PET flakes constantly moving in the hopper and prevents them from sticking together. The dried polyester flake 171 exits the drying unit 162 via a feeding-extruder because PET flakes are bulky and cause problems when they are fed by gravity.

The seventh step 170 of the process 100 involves collecting the polyester flake 171. The polyester flake 171 can then be used to manufacture final products, such as bottles or containers. As would be within the knowledge of an artisan, not all of the steps outlined above for the process 100 need to be completed for all MRF bales 111. For example, certain steps might be omitted as optional depending on a particular application (such as the desired purity of the polyester flake 171).

Absent the process 100 of the present disclosure, the recycling industry must continue to independently process bulk, resin-grade, post-consumer, curb-side materials. Independent processes must be applied to recycle polyolefins (PE and PP) and polyesters (PET) separately. The current processes are not only inefficient, the processes fail to recycle large amounts of valuable plastics because (1) in a primary process for Product A (e.g., polyolefin), Product B (e.g., polyester) is a waste stream, and (2) in a primary process for Product B (e.g., polyester), Product A (e.g., polyolefin) is a waste stream. The process 100 avoids such waste by collecting both Product A and Product B and, in an integrated process, recycling by re-directing Product A and Product B in parallel to their respective processing lines. The integrated process 100 of the integrated plastic recycling center 430 can separate different plastic feedstocks and yield valuable recycled products (e.g., the polyolefin flake 151 and the polyester flake 171) suitable for many different applications including but not limited to food grade applications. Different plastic feedstocks such as polyolefin and polyester are aggregated and processed in the same facility. The integrated process 100 eliminates individual processes and inefficiencies by automating multi-stream processing to achieve higher yields, diversion, circularity, and less residuals.

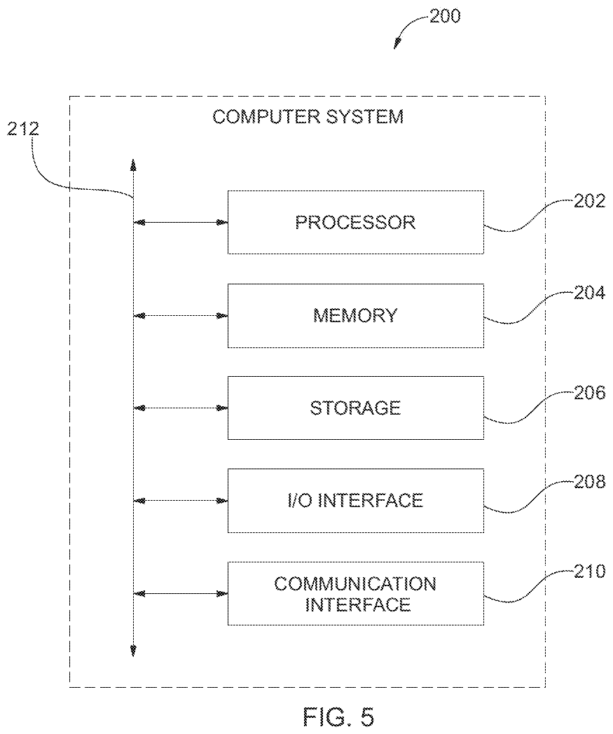

FIG. 5 illustrates an example computer system 200 that can be used in the process 100. In other words, the computer system 200 can be used to control the various components (e.g., the optical sorter 122, the shredder 132, the friction washing machine 142, the sink float tank 152, and the drying unit 162—and the subcomponents and functionality of these various components) that combine to perform the process 100.

In particular embodiments, one or more computer systems 200 perform one or more steps of one or more embodiments of the process 100 described or illustrated in this document. In particular embodiments, one or more computer systems 200 provide functionality described or illustrated in this document. In particular embodiments, software running on one or more computer systems 200 performs one or more steps of one or more embodiments of the process 100 described or illustrated in this document or provides functionality described or illustrated in this document. Particular embodiments include one or more portions of one or more computer systems 200. In this document, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates the computer system 200 taking any suitable physical form. As example and not by way of limitation, the computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these devices. Where appropriate, the computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more embodiments of the process 100 described or illustrated in this document. As an example and not by way of limitation, the one or more computer systems 200 may perform in real time or in batch mode one or more steps of one or more embodiments of the process 100 described or illustrated in this document. The one or more computer systems 200 may perform at different times or at different locations one or more steps of one or more embodiments of the process 100 described or illustrated in this document, where appropriate.

In particular embodiments, the computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 202 includes hardware for executing instructions, such as those making up a computer program. As an example and not by way of limitation, to execute instructions, the processor 202 may retrieve (or fetch) the instructions from an internal register, an internal cache, the memory 204, or the storage 206; decode and execute them; and then write one or more results to an internal register, an internal cache, the memory 204, or the storage 206. In particular embodiments, the processor 202 may include one or more internal caches for data, instructions, or addresses. This disclosure contemplates the processor 202 including any suitable number of any suitable internal caches, where appropriate. As an example and not by way of limitation, the processor 202 may include one or more instruction caches, one or more data caches, and one or more translation lookaside buffers (TLBs). Instructions in the instruction caches may be copies of instructions in the memory 204 or the storage 206, and the instruction caches may speed up retrieval of those instructions by the processor 202. Data in the data caches may be copies of data in the memory 204 or the storage 206 for instructions executing at the processor 202 to operate on; the results of previous instructions executed at the processor 202 for access by subsequent instructions executing at the processor 202 or for writing to the memory 204 or the storage 206; or other suitable data. The data caches may speed up read or write operations by the processor 202. The TLBs may speed up virtual-address translation for the processor 202. In particular embodiments, the processor 202 may include one or more internal registers for data, instructions, or addresses. This disclosure contemplates the processor 202 including any suitable number of any suitable internal registers, where appropriate. Where appropriate, the processor 202 may include one or more arithmetic logic units (ALUs); be a multi-core processor; or include one or more processors 202. Although this disclosure describes and illustrates a particular processor, this disclosure contemplates any suitable processor.

In particular embodiments, the memory 204 includes main memory for storing instructions for the processor 202 to execute or data for the processor 202 to operate on.

As an example and not by way of limitation, the computer system 200 may load instructions from the storage 206 or another source (such as, for example, another computer system 200) to the memory 204. The processor 202 may then load the instructions from the memory 204 to an internal register or internal cache. To execute the instructions, the processor 202 may retrieve the instructions from the internal register or internal cache and decode them. During or after execution of the instructions, the processor 202 may write one or more results (which may be intermediate or final results) to the internal register or internal cache. The processor 202 may then write one or more of those results to the memory 204. In particular embodiments, the processor 202 executes only instructions in one or more internal registers or internal caches or in the memory 204 (as opposed to the storage 206 or elsewhere) and operates only on data in one or more internal registers or internal caches or in the memory 204 (as opposed to the storage 206 or elsewhere). One or more memory buses (which may each include an address bus and a data bus) may couple the processor 202 to the memory 204. The bus 212 may include one or more memory buses, as described below. In particular embodiments, one or more memory management units (MMUs) reside between the processor 202 and the memory 204 and facilitate accesses to the memory 204 requested by the processor 202. In particular embodiments, the memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. The memory 204 may include one or more memories 204, where appropriate. Although this disclosure describes and illustrates particular memory, this disclosure contemplates any suitable memory.

In particular embodiments, the storage 206 includes mass storage for data or instructions. As an example and not by way of limitation, the storage 206 may include a hard disk drive (HDD), a floppy disk drive, flash memory, an optical disc, a magneto-optical disc, magnetic tape, or a Universal Serial Bus (USB) drive or a combination of two or more of these. The storage 206 may include removable or non-removable (or fixed) media, where appropriate. The storage 206 may be internal or external to the computer system 200, where appropriate. In particular embodiments, the storage 206 is non-volatile, solid-state memory. In particular embodiments, the storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates the storage 206 taking any suitable physical form. The storage 206 may include one or more storage control units facilitating communication between the processor 202 and the storage 206, where appropriate. Where appropriate, the storage 206 may include one or more storages 206. Although this disclosure describes and illustrates particular storage, this disclosure contemplates any suitable storage.

In particular embodiments, the I/O interface 208 includes hardware, software, or both, providing one or more interfaces for communication between the computer system 200 and one or more I/O devices. The computer system 200 may include one or more of these I/O devices, where appropriate. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, the I/O interface 208 may include one or more device or software drivers enabling the processor 202 to drive one or more of these I/O devices. The I/O interface 208 may include one or more I/O interfaces 208, where appropriate. Although this disclosure describes and illustrates a particular I/O interface, this disclosure contemplates any suitable I/O interface.

In particular embodiments, the communication interface 210 includes hardware, software, or both providing one or more interfaces for communication (such as, for example, packet-based communication) between the computer system 200 and one or more other computer systems 200 or one or more networks. As an example and not by way of limitation, the communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, the computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. The computer system 200 may include any suitable communication interface 210 for any of these networks, where appropriate. The communication interface 210 may include one or more communication interfaces 210, where appropriate. Although this disclosure describes and illustrates a particular communication interface, this disclosure contemplates any suitable communication interface.

In particular embodiments, the bus 212 includes hardware, software, or both coupling components of the computer system 200 to each other. As an example and not by way of limitation, the bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. The bus 212 may include one or more buses 212, where appropriate. Although this disclosure describes and illustrates a particular bus, this disclosure contemplates any suitable bus or interconnect.

In this document, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of the processor 202 (such as, for example, one or more internal registers or caches), one or more portions of the memory 204, one or more portions of the storage 206, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. In this document, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), JavaScript Object Notation (JSON) or other suitable markup language.

Whether implemented using the computer system 200 or not, the automated process 100 offers a number of advantages. Among those advantages is that the process 100 enables involuntary generators to recycle different types of plastics in a common container. The process 100 shreds a mix of recyclable plastic waste materials 10 including, but not limited to LLDPE, LDPE, HDPE, PE, PP, and PS. The process 100 provides an automated separation of a mix of recyclable plastic commodities. The process 100 provides feedstock and acts as a source for a variety of downstream recycling methods including but not limited to mechanical, chemical (pyrolysis, gasification), solvent, and biological treatment. Without the process 100, these downstream recycling methods will not get a recyclable feedstock from mixed plastic waste streams.

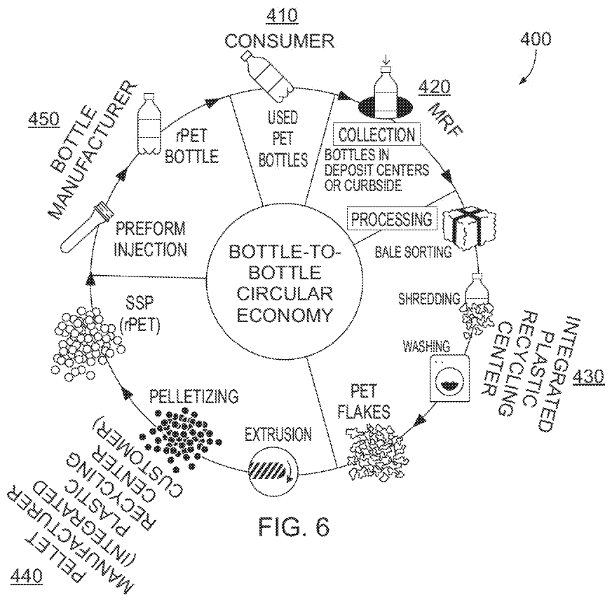

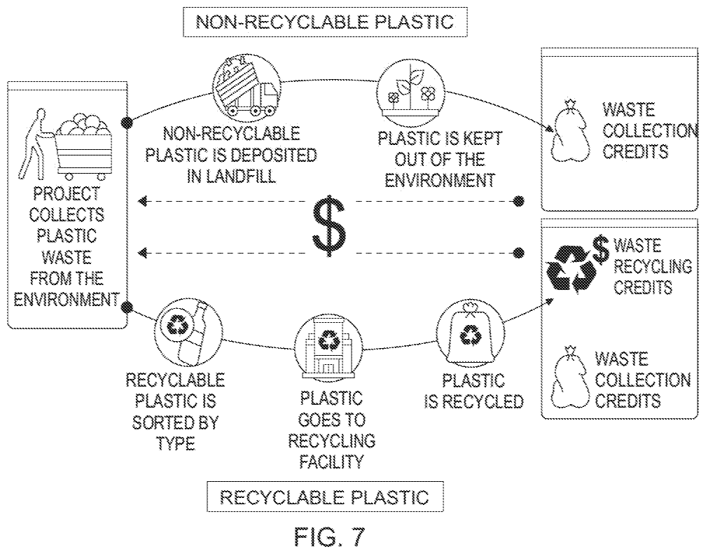

Because the process 100 creates separate streams of relatively pure polyolefin flake 151 and polyester flake 171, the process 100 further achieves a number of plastics-related advantages. These advantages of the process 100 are explained with the help of FIGS. 6 and 7.

FIG. 6 illustrates an ecosystem 400 for the circular plastic bottle economy, focusing on recycling beverage bottles made of PET. PET is one of the few thermoplastics that can be recycled to achieve resin-like quality through solid state polycondensation (“SSP”). The cycle begins when a consumer 410 disposes properly of a used PET bottle. The MRF 420 collects the bottles (typically in deposit centers or curbside). The collected bottles are then processed into PET flakes. Such processing occurs at the integrated plastic recycling center 430.

The integrated plastic recycling center 430 allows the operator to step into mechanical reprocessing, freeing pellet manufacturers to focus on their core competencies around the SSP process. The integrated plastic recycling center 430 does this at scale, freeing-up currently encumbered assets and production floor space at pellet manufacturers—unlocking value for them. In addition, the integrated plastic recycling center 430 creates ecosystem efficiencies as current pellet manufacturers treat non-targeted plastic resins as residual. The integrated plastic recycling center 430 provides leverage and scale for capturing upside value for recycled plastics.

FIG. 6 shows some of the steps of an example process flow for recycling PET. Those steps include: (1) de-baling in which bales of PET are loaded and separated; (2) optical sorting in which near-infrared (NIR) cameras detect PET on a conveyor belt; (3) label and sleeve removal in which labels and sleeves are removed; (4) second optical sorting in which clear and color PET are separated; (5) manual picking in which any remaining unwanted material is removed; (6) granulation in which PET is cut into flakes (e.g., 12 mm in size); (7) washing and drying in which the flakes are washed and separated by density; and (8) flake sorting and bagging in which the flakes are sorted by size and color and bagged. Thereafter, the PET flakes are sent to a pellet manufacturer 440, i.e., a customer of the operator of the integrated plastic recycling center 430. The pellet manufacturer 440 melts the flakes and cuts them into food-grade pellets. After pelletizing, SSP creates the recycled PET (or “rPET”) that the bottle manufacturer 450 uses to make a new bottle and complete the cycle.

In short, rPET takes plastic that has already been created, usually plastic bottles, and chops the bottles into tiny flakes. These flakes are then melted to separate the core PET ingredient inside of the bottle. This PET can then be used to make anything from a sweater to another plastic bottle. Not only is up to 50% less energy used than making PET from scratch, but by using existing bottles already created, it ensures these bottles do not end up in a landfill. It also means that the planet remains as it is: rather than obtaining the core ingredient via the highly damaging process of crude oil primary extraction, use is made of a product in abundance that may otherwise have directly contributed to landfill.

Although FIG. 6 focuses on the ecosystem 400 and one example of recycling PET bottles, an artisan will readily recognize the advantages achieved using the process 100 of the subject disclosure in the ecosystem 400. The MRF 420 is not limited to collecting bottles; rather, the process 100 accepts a mix of plastic waste material 10 which would include bottles.

The process 100 enables a huge opportunity to convert previously unrecyclable plastics to commercial, industrial-grade products including but not limited to food, medical, and chemical applications. The operators of the process 100 will be able to drive plastics circularity by manufacturing recycled products. The applications include but are not limited to consumer packaging, industrial pyrolysis oil, durable goods, films, pellets, and the like.

The process 100 enables plastic credits between the manufacturers, consumers, users, and recyclers of plastics. Recovering LDPE film that would otherwise be landfilled creates plastic waste recycling credits under a certified standard including but not limited to the Verra Plastic Waste Reduction Standard which sets a standard to establish criteria to create plastic credit. See https://verra.org. Verra develops and manages standards that are globally applicable and advance action across a wide range of sectors and activities. The Verra standards and programs are trusted by a broad range of stakeholders, provide innovative solutions to environmental and social problems, and work for people and the planet by supporting projects and activities that deliver a range of benefits to communities and their surrounding environments.

The Verra Plastic Program projects include a range of plastic waste collection and recycling activities that reduce the amount of plastic waste in the environment and the use of virgin plastic. FIG. 7 illustrates the flow of material and credits in a Plastic Standard project example in which plastic waste is collected from the environment. In this example, the non-recyclable plastic waste is sent to a landfill resulting in Waste Collection Credits and the recyclable plastic waste is sent to a recycler resulting in both Waste Collection Credits and Waste Recycling Credits.

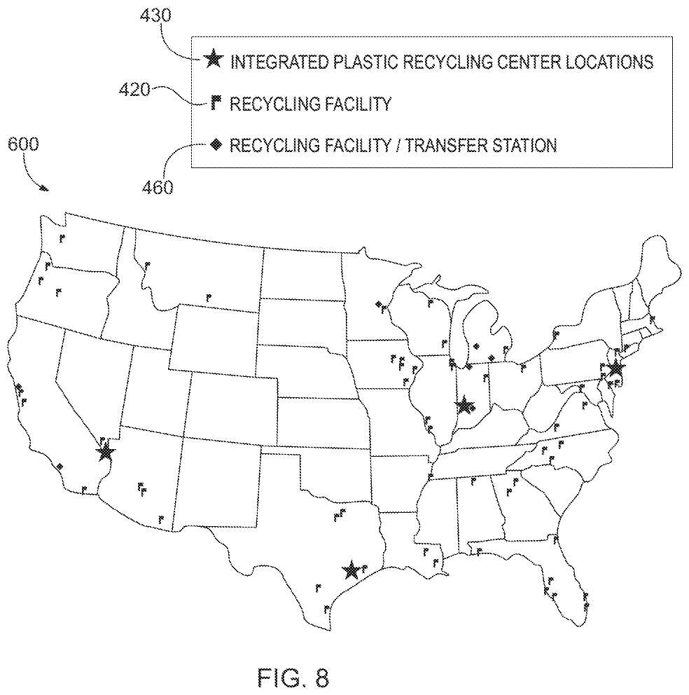

FIG. 8 illustrates an example embodiment of a nationwide hub and spoke infrastructure 600 for recycling a broad mix of plastic waste material 10 made possible by the integrated plastic recycling centers 430. As illustrated, a plurality of integrated plastic recycling centers 430 can be located in selected cities around the country. Four locations are shown, one each in the North, South, East, and West. Four locations constitute merely one example; the number of locations may vary depending on many factors as would be known to an artisan. The locations of the integrated plastic recycling centers 430 should be selected to provide coverage across the United States around existing MRFs 420 and build geographic density.

Each integrated plastic recycling center 430 receives mixed plastic waste material 10 from a number of MRFs 420. To facilitate transportation of the mixed plastic waste material 10 from the MRFs 420 to a particular integrated plastic recycling center 430, the MRFs 420 that provide mixed plastic waste material 10 to a particular integrated plastic recycling center 430 are located in relative geographic proximity to the integrated plastic recycling center 430. Thus, for example, the MRFs 420 that provide mixed plastic waste material 10 to the integrated plastic recycling center 430 in the West are located in the Western part of the United States (eleven such MRFs 420 are shown in this example). A plurality of recycling facility/transfer stations 460 can be included to receive mixed plastic waste material 10 from another MRF 420 and relay that material to the proximate integrated plastic recycling center 430 along with the mixed plastic waste material 10 collected by the recycling facility/transfer station 460 itself. The recycling facility/transfer stations 460 further facilitate transportation of the mixed plastic waste material 10 from the MRFs 420 to the integrated plastic recycling centers 430.

The integrated plastic recycling center 430 can also fractionate olefins into discreet colors and segregate food-grade packaging from non-food-grade. The hub and spoke infrastructure 600 uniquely allows concentration of sufficient volume of like materials such that this fractionation can be achieved at palatable expense. A benefit of sorting by color and food grade is that a far greater portion of the material (e.g., white milk jugs, orange detergent bottles, or clear carry-out tubs) can be recycled into consumer packaging, enabling circularity. By contrast, conventional processes downcycle virtually all olefins (except for clear milk jugs) into black durable goods which cannot be recycled again at end of life.

The hub and spoke infrastructure 600 offers several advantages. Among those advantages are that the hub and spoke infrastructure 600: leverages economies of scale and aggregates mixed plastics from several recycling facilities and sorts them into purified recycled streams for end-customers; provides configurable lines to address stream complexity; simplifies plastics handling at existing recycling centers by shifting complex processing into a centralized facility (i.e., the inverse of a manufacturing-to-distribution warehousing model); reduces capital expenditure and operating expenditure at recycling facilities; and homogenizes curbside programs across feeder markets regardless of local recycling processing capabilities through centralizing complexity at the recycling facility location. In short, the hub and spoke infrastructure 600 aggregates volume at scale and captures the upside value for recycled plastics.

Recycling facilities currently face tradeoffs between recovery and purity. The more waste material that is recovered, the greater is the need for quality management. Conversely, if higher-quality products need to be shipped, more desirable material will be missed and will find its way to the residue. This disclosure eliminates the tradeoff by introducing a process of integrated secondary processing of contaminated material without sacrificing recovery and purity at MRFs. The integrated process also permits simultaneous handling of polyesters and polyolefins.

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. An automated process for separating and recycling a broad mix of plastic waste material including, but not limited to, polyolefin and polyester streams, the process comprising:
collecting the broad mix of plastic waste material;
pre-processing the broad mix of plastic waste material to remove contamination from the broad mix of waste material;
coarsely shredding or grinding the broad mix of plastic waste material, resulting in ground material;
friction washing the ground material to remove dirt, sand, grease, and other contaminants from the ground material and to form cleaned ground material;
sink floating the cleaned ground material to further wash and separate the clean ground material into recycled polyolefin and polyester remainder;
drying the polyester remainder, resulting in recycled polyester; and
collecting the recycled polyester.

2. The automated process according to claim 1 wherein the broad mix of plastic waste material that is collected includes one or more of polyethylene, polyethylene terephthalate, linear low density polyethylene, low density polyethylene, polypropylene, high density polyethylene, and polystyrene.

3. The automated process according to claim 1 wherein the step of pre-processing the broad mix of plastic waste material results in a premium bale.

4. The automated process according to claim 1 further comprising, after collecting the broad mix of plastic waste material, transporting the collected broad mix of plastic waste material to an integrated plastic recycling center where pre-processing occurs.

5. The automated process according to claim 1 wherein the step of pre-processing includes optical sorting the broad mix of plastic waste material.

6. The automated process according to claim 1 wherein the step of drying the polyester remainder is done at temperature levels of about 160-180° C. to a moisture content below about 0.005%.

7. The automated process according to claim 1 wherein the recycled polyolefin comprises flakes of polyolefin.

8. The automated process according to claim 1 wherein the recycled polyester comprises flakes of polyester.

9. The automated process according to claim 1 wherein the contamination removed from the broad mix of plastic waste material during pre-processing does not include plastics.

10. The automated process according to claim 1 wherein the contamination removed from the broad mix of plastic waste material during pre-processing includes non-recyclable plastic, and the process further comprises:
sending the non-recyclable plastic to a landfill resulting in waste collection credits under a certified standard; and
sending the recycled polyolefin and the recycled polyester to one or more recyclers resulting in both waste collection credits and waste recycling credits under a certified standard.

11. The automated process according to claim 1 further comprising pelletizing the recycled polyester into pellets and subjecting the pellets to solid state polycondensation.

12. An integrated plastic recycling center for separating and recycling a broad mix of plastic waste material including, but not limited to, polyolefin and polyester streams, the center comprising:
a mechanism for collecting the broad mix of plastic waste material;
an optical sorter for pre-processing the broad mix of plastic waste material to remove contamination from the broad mix of plastic waste material;
a shredder for coarsely shredding or grinding the broad mix of plastic waste material, resulting in ground material;
a friction washing machine for removing dirt, sand, grease, and other contaminants from the ground material;
a sink float separation tank for further washing and separating the ground material, resulting in recycled polyolefin and polyester remainder; and
a dryer unit for drying the polyester remainder, resulting in recycled polyester.

13. The integrated plastic recycling center according to claim 12 wherein the sink float separation tank uses water as a medium to separate the ground material based on densities.

14. The integrated plastic recycling center according to claim 12 wherein the broad mix of plastic waste material that is collected by the mechanism includes one or more of polyethylene, polyethylene terephthalate, linear low density polyethylene, low density polyethylene, polypropylene, high density polyethylene, and polystyrene.

15. The integrated plastic recycling center according to claim 12 wherein the recycled polyolefin comprises flakes of polyolefin, the recycled polyester comprises flakes of polyester, or both.

16. The integrated plastic recycling center according to claim 12 wherein the optical sorter fractionates polyolefins into discreet colors and segregates food-grade packaging from non-food-grade packaging.

17. A hub and spoke infrastructure for separating and recycling a broad mix of plastic waste material including, but not limited to, polyolefin and polyester streams, the infrastructure comprising:
a plurality of materials recovery facilities collecting a first portion of the broad mix of plastic waste material;
a number of recycling facility/transfer stations both collecting a second portion of the broad mix of plastic waste material and receiving from at least one materials recovery facility the mixed plastic waste material collected by the at least one materials recovery facility; and
multiple integrated plastic recycling centers according to claim 12, each center collecting the broad mix of plastic waste material from one or more of the plurality of materials recovery facilities, from one or more of the recycling facility/transfer stations, or from both one or more of the plurality of materials recovery facilities and one or more of the recycling facility/transfer stations,
wherein each of the multiple centers is located geographically in relative proximity to the one or more materials recovery facilities, the one or more recycling facility/transfer stations, or to both the one or more materials recovery facilities and the one or more recycling facility/transfer stations from which the center collects the broad mix of plastic waste material.

18. One or more computer-readable non-transitory storage media embodying software that is operable when executed to:
collect a broad mix of plastic waste material including, but not limited to, polyolefin and polyester streams;
pre-process the broad mix of plastic waste material to remove contamination from the broad mix of plastic waste material;
coarsely shred or grind the broad mix of plastic waste material, resulting in ground material;
friction wash the ground material to remove dirt, sand, grease, and other contaminants from the ground material;
sink float the ground material to further wash and separate the ground material, resulting in recycled polyolefin and polyester remainder;
dry the polyester remainder, resulting in recycled polyester; and
collect the recycled polyester.

19. An integrated process that constitutes recycling facilities and secondary processing centers with enhanced sorting, separating, and processing capabilities, the process comprising:
delivering a stream or streams of recyclable waste material to recycling facilities wherein large volume materials including cardboard, glass, aluminum, and steel are sorted, baled, and sold to converters;
sending remaining material to secondary processing centers for further refinement, wherein the recycling facility enables market area collection and the secondary processing center is a larger regional hub;
aggregating material on a regional basis; and
sending a concentrated stream of difficult-to-process material through a purpose-built separation process step which would not be practical or economical on a de-centralized basis.

20. The integrated process according to claim 19, further comprising separating the difficult-to-process material that includes rigid plastics into bales of primarily polyester in a first line and primarily polyolefin in a second line.
